(19) United States
(12) Patent Application Publication
(10) Pub. No.: US 2015/0373220 A1
(43) Pub. Date: Dec. 24, 2015

(54) IMAGE PROCESSING APPARATUS AND IMAGE PROCESSING SYSTEM

(71) Applicants: KABUSHIKI KAISHA TOSHIBA, Tokyo (JP); TOSHIBA TEC KABUSHIKI KAISHA, Tokyo (JP)

(72) Inventor: Shinji Koizumi, Numazu-shi (JP)

(21) Appl. No.: 14/309,163

(22) Filed: Jun. 19, 2014

(51) Int. Cl. H04N 1/00

(52) U.S. Cl. CPC H04N 1/00822; H04N 1/00801; H04N 1/00005; H04N 1/00087; H04N 1/00018

(57) ABSTRACT

In accordance with one embodiment, an image processing apparatus comprises a target data acquisition section, an identifier information acquisition section and an image forming section. The target data acquisition section acquires image data which is to be printed on a sheet. The identifier information acquisition section acquires identifier information indicating an identifier which is to be printed on the sheet together with the image data and is used for specifying the handling of scanning data acquired when scanning the sheet printed with the identifier. The image forming section forms, when forming an image based on the image data acquired by the target data acquisition section on a sheet, an image indicating the identifier information acquired by the identifier information acquisition section together with the image data on the sheet.

### BACKGROUND

Conventionally, in a case of carrying out scanning processing using an image reading apparatus, a user executes the scanning processing according to a desired scan setting. Further, in the scanning processing, there is scan setting recommended depending on the image to be scanned. However, there is a problem that the scan setting operation is troublesome and it is difficult for the user to carry out optimized scan setting.

### DESCRIPTION OF THE DRAWINGS

FIG. 1 is a schematic diagram illustrating an image processing apparatus according to a first embodiment;

FIG. 2 is a block diagram illustrating the hardware constitution of the image processing apparatus according to the first embodiment;

FIG. 3 is a flowchart illustrating an image forming processing carried out in the image processing apparatus according to the first embodiment;

FIG. 4 is a diagram illustrating an input screen for inputting scan setting information contained in a QR code;

FIG. 5 is a diagram illustrating a sheet on which the QR code is printed;

FIG. 6 is a flowchart illustrating an image reading processing carried out in the image processing apparatus according to the first embodiment;

FIG. 7 is a diagram illustrating a sheet group to be scanned;

FIG. 8 is an example of a data table which illustrates the relation between the sheet and the scan setting content; and

FIG. 9 is a flowchart illustrating an image forming processing carried out in the image processing apparatus according to a second embodiment.

### DETAILED DESCRIPTION

In accordance with one embodiment, an image processing apparatus comprises a target data acquisition section, an identifier information acquisition section and an image forming section. The target data acquisition section acquires image data which is to be printed on a sheet. The identifier information acquisition section acquires identifier information indicating an identifier which is to be printed on the sheet together with the image data and is used for specifying the handling of scanning data acquired when scanning the sheet printed with the identifier. The image forming section forms, when forming an image based on the image data acquired by the target data acquisition section on a sheet, an image indicating the identifier information acquired by the identifier information acquisition section together with the image data on the sheet.

In the present embodiment, the image processing apparatus forms an image on a sheet and meanwhile prints an identifier on the sheet. The identifier is, for example, a QR code, and is capable of containing information of scan setting. In a case of scanning a sheet printed with the identifier in the image processing apparatus, the image processing apparatus executes scanning processing according to the scan setting information contained in the identifier.

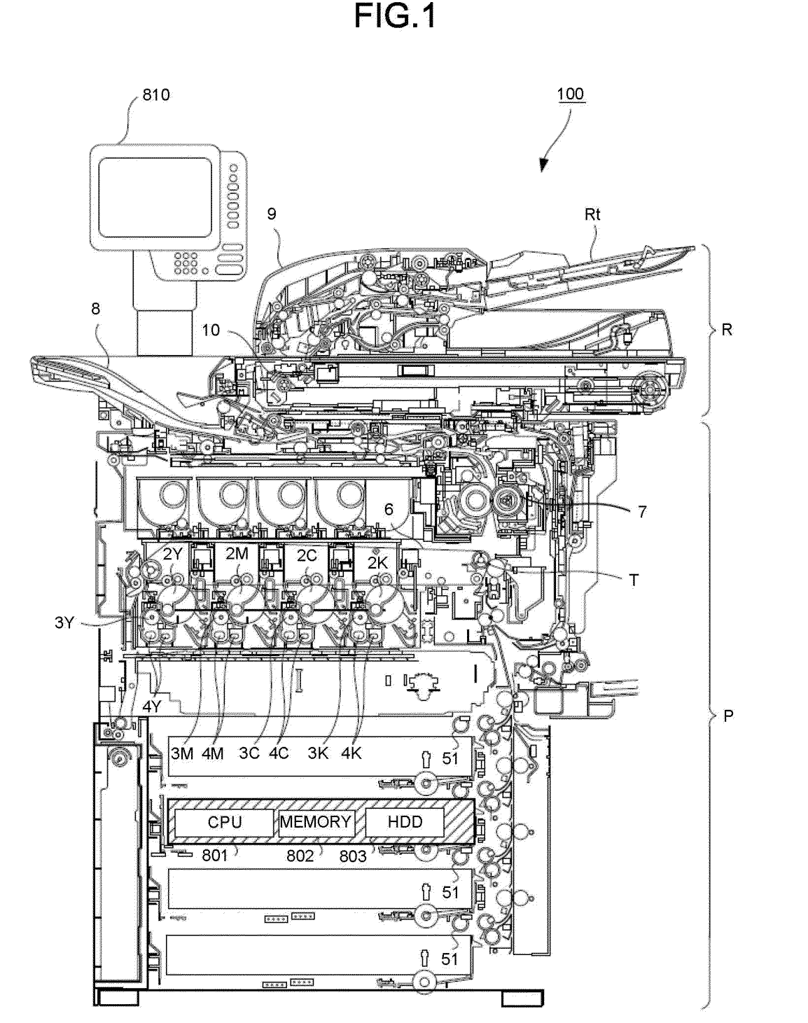

FIG. 1 is a schematic diagram illustrating image processing apparatus according to the present embodiment.

An image processing apparatus 100 comprises a reading section R and an image forming section P.

The reading section R has a function of scanning and reading images on a sheet document and a book document. The reading section R is provided with a scanning optical system 10 which includes a plurality of reflecting mirrors and image capturing elements, and an auto document feeder (ADF) 9 which is capable of conveying a document to a given placing position automatically. The image on the document placed on a document tray Rt and automatically conveyed by the auto document feeder 9 and the image on the document placed on a document table (not shown) are read by the scanning optical system 10.

The image forming section P has a function of forming a developer image on a sheet based on the image read by the reading section R from the document or the image data sent to the image processing apparatus 100 from an external machine. The image processing apparatus 100 comprises a CPU 801, a memory 802 and a HDD 803. The CPU 801 is an arithmetic processing device such as a CPU (Central Processing Unit), a MPU (Micro Processing Unit) and the like. The CPU 801 carries out various processing in the image processing apparatus 100, and loads and executes the program pre-stored in the memory 802 to achieve various functions.

The memory 802 is a storage section consisting of a RAM (Random Access Memory) serving as a primary storage device and a non-volatile storage device such as a flash memory and the like. The HDD 803 is a storage section consisting of a non-volatile storage device serving as a so-called hard disk drive.

Further, the image processing apparatus 100 is provided with an operation input section 810. The operation input section 810 includes a touch panel type input section for receiving an instruction from a user and a flat-type display section for displaying processing content or a message and the like to the user and displaying a preview image of a printing target before the printing processing.

A copy processing is schematically described below as an example of the processing carried out in the image processing apparatus 100 according to the present embodiment.

First, the sheet picked up by a pickup roller 51 is fed to a sheet conveyance path. The sheet fed to the sheet conveyance path is conveyed by a plurality of roller pairs towards a given conveyance direction.

Then, the images on a plurality of sheet documents automatically conveyed by the auto document feeder 9 continuously are read by the scanning optical system 10.

Next, a control board 800 carries out a given image processing on the image data read by the reading section R from the document. Sequentially, electrostatic latent images of the data subjected to the image processing are formed on photoconductive surfaces of photoconductive drums 2Y, 2M, 2C and 2K for transferring yellow (Y), magenta (M), cyan (C) and black (K) developer images to the sheet.

Then, the developing agent mixed by mixers 4Y-4K in developing devices is supplied by developing rollers (so-called mag rollers) 3Y-3K for the photoconductive drums 2Y-2K on which the electrostatic latent images are formed in the way described above. In this way, the electrostatic latent images formed on the photoconductive surfaces of the photoconductive drums are developed.

The developer images formed on the photoconductive drums in such a way are transferred (so-called primary transfer) to the surface of an intermediate transfer belt 6, and the developer images conveyed through the rotation of the intermediate transfer belt are transferred to the sheet at a given secondary transfer position T.

The developer images transferred to the sheet are fixed on the sheet by a fixing device 7. The sheets on which the developer images are fixed are conveyed on the conveyance path by a plurality of conveyance roller pairs and then discharged to a discharge tray 8 in sequence.

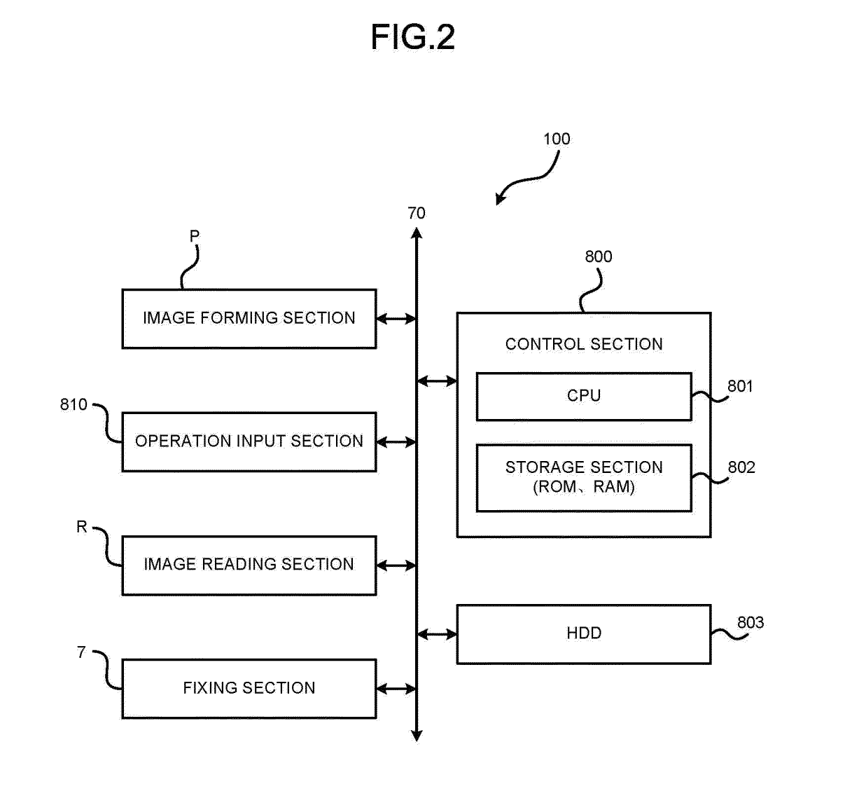

FIG. 2 is a block diagram illustrating the hardware constitution of the image processing apparatus according to the present embodiment.

In the image processing apparatus 100, the image forming section P, the operation input section 810, the image reading section R, the control section 800, the fixing section 7 and the HDD 803 are connected with each other through a communication bus 70.

The control section 800, which consists of the CPU 801 and the storage section 802, controls the operations of the image processing apparatus 100.

The CPU 801, which is an arithmetic processing device, loads the computer program pre-stored in the HDD 803 and the like into the memory 802 and executes the computer program to achieve various functions. The storage section 802, which consists of a ROM (read only memory), a RAM (Random Access Memory), an EEPROM (Electrically Erasable Programmable Read-Only Memory) and the like, stores computer program used in the control process carried out by the control section 800 and the data generated during the execution process of the computer program.

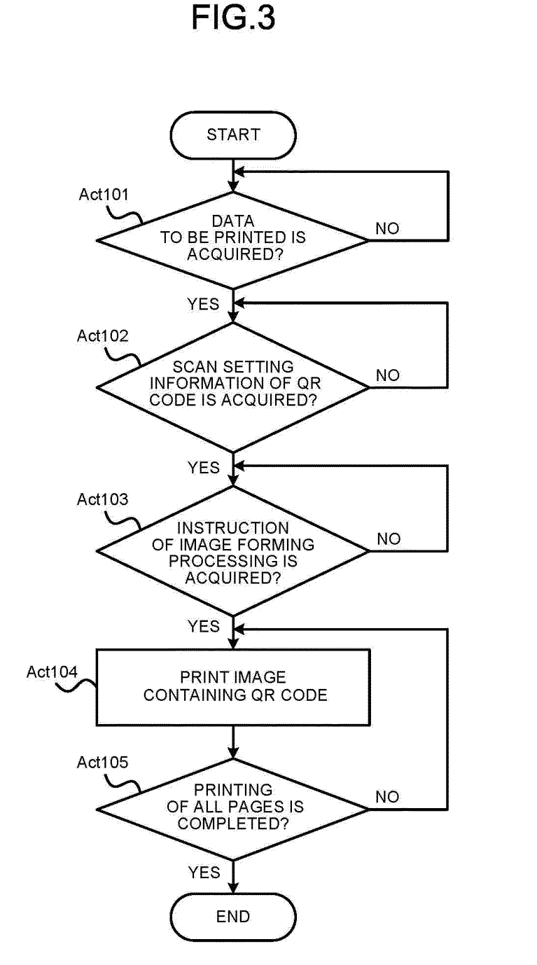

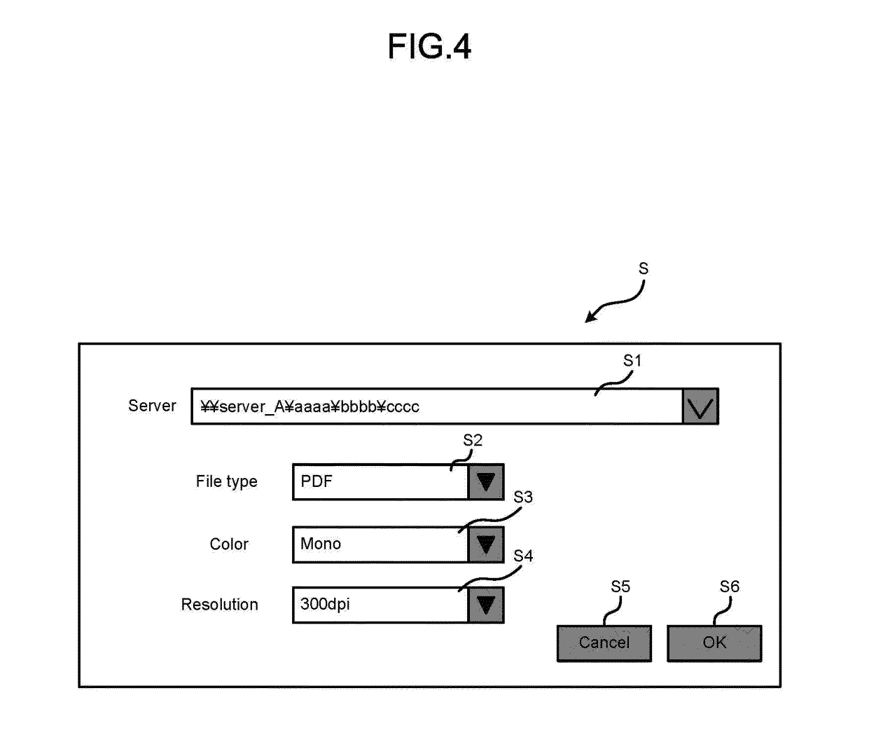

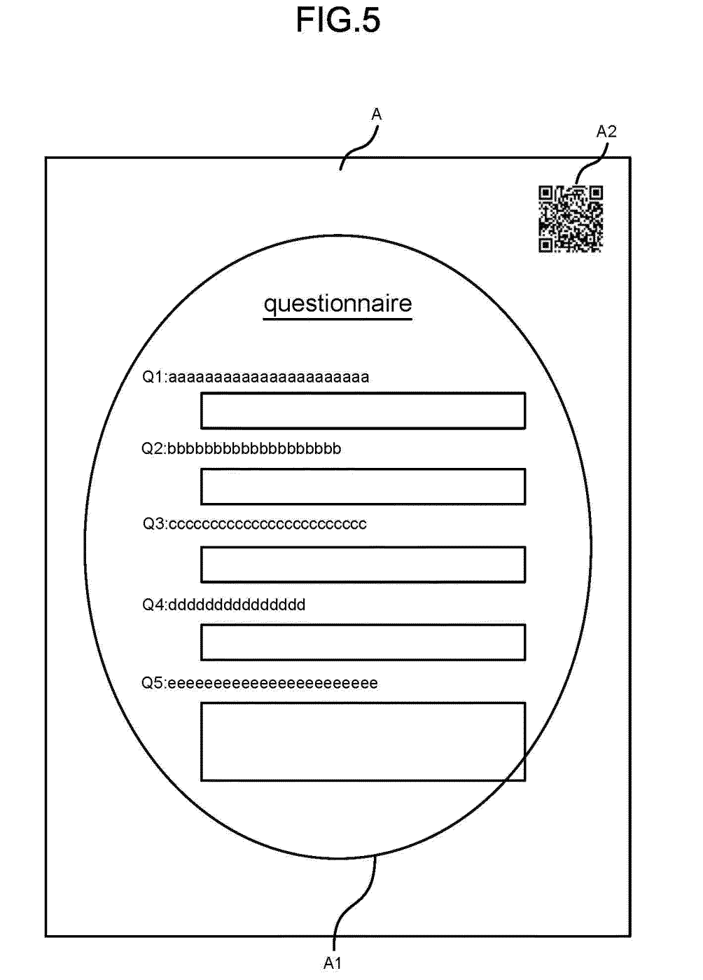

FIG. 3 is a flowchart illustrating an image forming processing carried out in the image processing apparatus according to the present embodiment. FIG. 4 is a diagram illustrating a screen which is incorporated in a printer driver and is used for inputting scan setting information contained in a QR code. FIG. 5 is a diagram illustrating the sheet on which the QR code is printed together with the printing target image data.

In ACT 101, if the control section 800 (target data acquisition section) acquires the data to be printed from the external machine connected with the image processing apparatus 100 (YES in ACT 101), the flow proceeds to ACT 102. On the other hand, in ACT 101, if the control section 800 (target data acquisition section) does not acquire the data to be printed (NO in ACT 101), the flow does not proceed to ACT 102. In the present embodiment, the data is the image data sent from the external machine connected with the image processing apparatus 100 and stored in the HDD 803. The data sent from the external machine may be, for example, Word (registered trademark) data, Excel (registered trademark) data, PDF data and the like. The data mentioned herein is not limited to be the data sent from the external machine, it may also be the image data read by the image reading section R of the image processing apparatus 100.

In ACT 102, if the control section 800 (identifier information acquisition section) acquires the scan setting information contained in the QR code from the data sent from the external machine (YES in ACT 102), the flow proceeds to ACT 103. On the other hand, in ACT 102, if the control section 800 (identifier information acquisition section) does not acquire the scan setting information contained in the QR code (NO in ACT 102), the flow does not proceed to ACT 103. The QR code is an identifier which is supposed to be printed together with a printing target image on the sheet to be subjected to image forming processing, and the QR code specifies the handling of the scanning data when scanning the sheet on which the QR code is printed.

The scan setting information contained in the QR code is input by a user through the external machine connected with the image processing apparatus 100. In the present embodiment, the scan setting information is input from an input screen S (shown in FIG. 4) which is arranged on the printer driver and is used for inputting the scan setting. The input screen S may be displayed, for example, on the operation input section 810 of the image processing apparatus 100 and the user can operate the operation input section 810 to input scan setting information. A storage destination selecting column S1, a file type selecting column S2, a color selecting column S3, an image resolution selecting column S4, a cancel button S5 and an OK button S6 are displayed on the input screen S. The storage destination of the image data scanned by the image processing apparatus 100 can be selected in the storage destination selecting column S1. The storage destination where the image data is to be stored may be, for example, the HDD 803 or the external machine such as a server connected with the image processing apparatus. The file type of the scanned image data can be selected in the file type selecting column S2. For example, a PDF type, a JPG type and a TIFF type can be selected as the file type. A color mode of the scanned image data can be selected in the color selecting column S3. For example, a full color, monochrome, auto color and the like can be selected as the color mode. The image resolution of the image data generated through the scanning processing can be selected in the image resolution selecting column S4. The image resolution may be selected from, for example, 100 dpi, 150 dpi, 200 dpi, 300 dpi, 400 dpi, 600 dpi and the like. If the user input the scan setting and selects the OK button S6, the input of the scan setting is completed. On the other hand, if the user selects the cancel button S5, the input of the scan setting is discontinued.

In ACT 103, if the control section 800 acquires an instruction of image forming processing from the printer driver installed in the external machine (YES in ACT 103), the flow proceeds to ACT 104. On the other hand, in ACT 103, if the control section 800 does not acquire the instruction of image forming processing (NO in ACT 103), the flow does not proceed to ACT 104. In the present embodiment, the user can instruct to execute image forming processing through the operation input section 810 of the image processing apparatus 100.

In ACT 104, the control section 800 controls the image forming section P to print the printing target image and the QR code on the sheet.

In ACT 105, if the image processing apparatus 100 completes the printing of all the pages which are supposed to be printed (YES in ACT 105), the printing processing in the flowchart is ended. On the other hand, in ACT 105, if the image processing apparatus 100 does not complete the printing of all the pages which are supposed to be printed (NO in ACT 105), the flow proceeds to ACT 104.

FIG. 5 is a diagram illustrating the sheet on which the QR code is printed.

On the sheet A on which an image is formed by the image processing apparatus 100, a target image A1 which is a target supposed to be formed on the sheet is formed at the center of the sheet A. Further, an identifier A2 is formed at a given position of the sheet A. Herein, the forming position of the identifier A2 is preferred to be a position which is not overlapped with the target image A1 on the sheet A. For example, the forming position of the identifier A2 is preferred to be the margin part of the sheet.

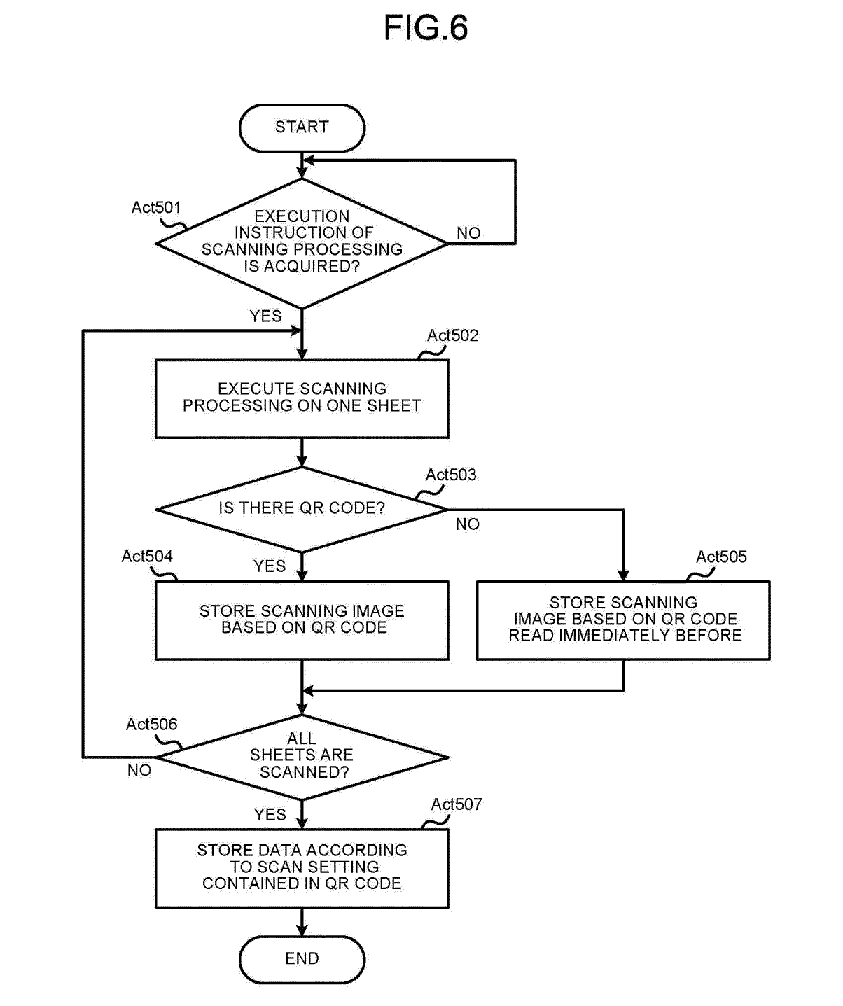

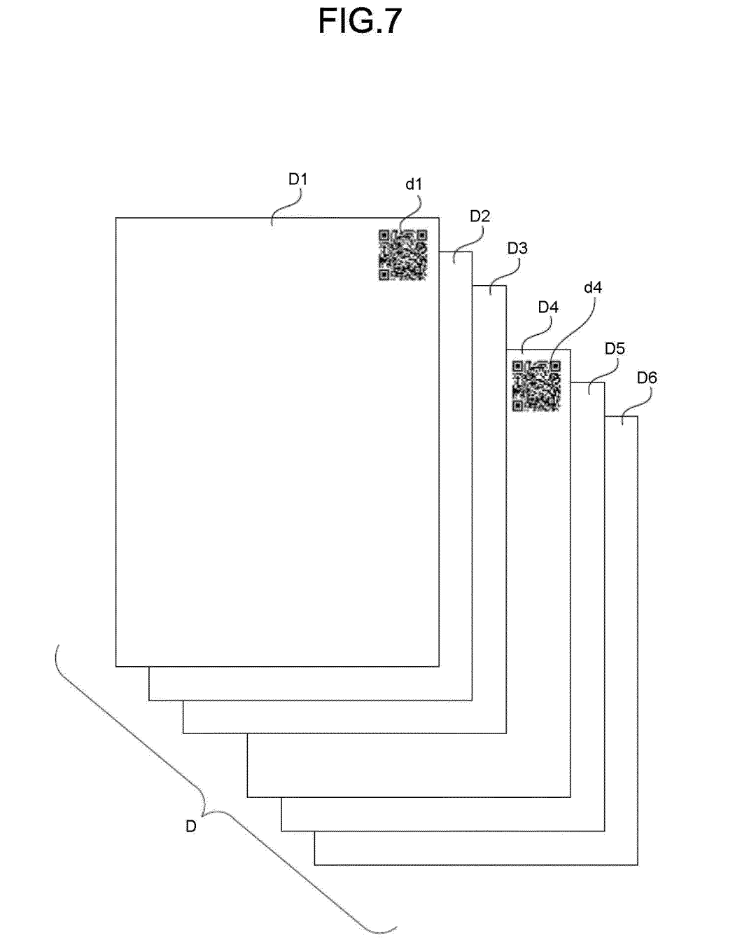

FIG. 6 is a flowchart illustrating an image reading processing carried out in the image processing apparatus according to the present embodiment. Further, FIG. 7 is a diagram illustrating a group of sheets to be scanned.

The image processing apparatus 100 scans the sheet on which the QR code is printed, generates image data based on the information of the QR code and then stores the image data.

In ACT 501, if the control section 800 acquires an execution instruction of scanning processing (YES in ACT 501), the flow proceeds to ACT 502. On the other hand, in ACT 501, if the control section 800 does not acquire the execution instruction of scanning processing (NO in ACT 501), the flow does not proceed to ACT 502. In the present embodiment, the execution instruction of scanning processing can be input through the operation input section 810.

In ACT 502, the control section 800 controls the image reading section R to read the image formed on the sheet A. The image reading section R reads the sheets A one by one.

In ACT 503, if the control section 800 (identifier information reading section) determines that the QR code is printed in the read image (YES in ACT 503), the flow proceeds to ACT 504. On the other hand, in ACT 503, if the control section 800 (identifier information reading section) determines that the QR code is not printed in the read image (NO in ACT 503), the flow proceeds to ACT 505.

In ACT 504, the control section 800 (identifier information reading section) controls the image reading section R to read image data, and stores the read image data in the memory 802 based on the information of the QR code. Herein, in a case where the scan setting in the QR code is set as following: the file type is PDF, the color mode is monochrome and the image resolution is 300 dpi; the image data is stored in the memory 802 based on the setting.

In ACT 505, the control section 800 (identifier information reading section) controls the image reading section R to read image data and stores the read image data in the memory 802 based on the information of the QR code which is read immediately before. The QR code read immediately before refers to a QR code printed on the sheet the image on which is read most recently within the sheets printed with the QR code. More specific description is carried out with reference to FIG. 7. The sheet group to be scanned in the image processing apparatus 100 is referred to as a sheet group D. The sheet group D is a group of sheets to be subjected to scanning processing at a time, and the user collectively places the sheet group D on the document tray Rt (refer to FIG. 1) and then executes scanning processing. Further, the sheet group D includes sheets D1-D6. In the sheet group D, a QR code d1 is printed on the sheet D1 and a QR code d4 is printed on the sheet D4. The sheet group D is subjected to scanning processing in such a manner that the sheet D1-sheet D6 are scanned in order. As to the sheet group D, for the sheet D2, the “QR code read immediately before” is the QR code d1 printed on the sheet D1. Further, for the sheet D6, the “QR code read immediately before” is the QR code d4 printed on the sheet D4.

In ACT 506, if all the sheets in the sheet group D (refer to FIG. 7) which are supposed to be collectively scanned at a time are scanned (YES in ACT 506), the flow proceeds to ACT 507. On the other hand, in ACT 506, if all the sheets in the sheet group D are not scanned (NO in ACT 506), the flow proceeds to ACT 502.

In ACT 507, the control section 800 (identifier information reading section) controls the image reading section R to store the scanned image data in the HDD 803 according to the information of the QR code. The image data stored in the HDD 803 is the image data stored in the memory 802 in ACT 504 and ACT 505, and the data is extracted from the memory 802 and then stored in the HDD 803 according to the information of the QR code.

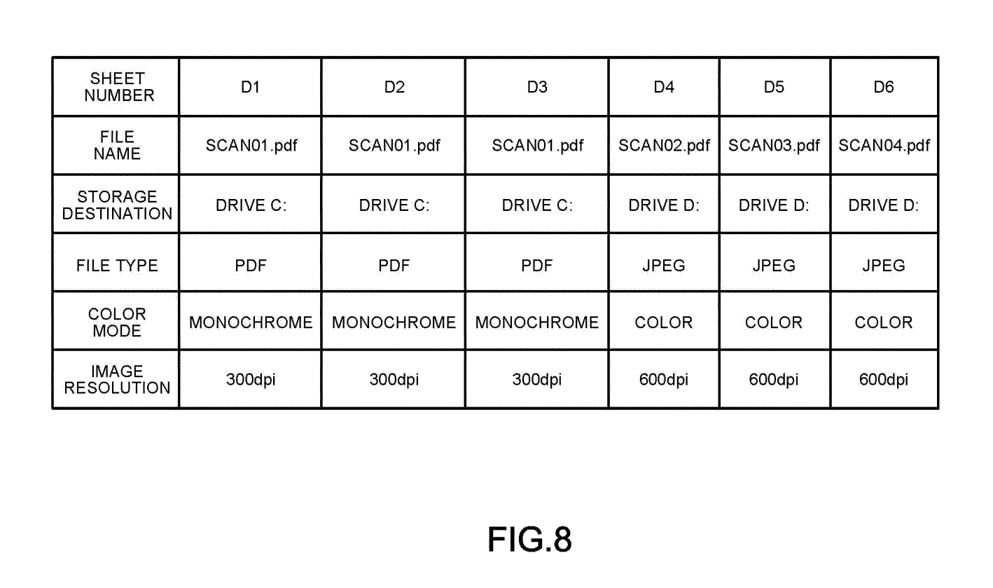

FIG. 8 is an example of a data table which illustrates the relation between the sheet and the scan setting content.

The data table illustrates the scan setting content of the sheet group D (refer to FIG. 7). As stated above, the scan setting content of the sheets D1-3 is based on the QR code d1 printed on the sheet D1. As it is set in the QR code d1 that the storage destination is drive C, the file type is PDF, the color mode is monochrome and the image resolution is 300 dpi, the image data is generated according to the same setting for the sheets D1-3. Herein, as the same image data is generated for the sheets D1-3, the sheets D1-3 are named with the same file name. Though it is not shown in FIG. 4, it may also be set that same image data is generated for a plurality of sheets, like the sheets D1-3. The scan setting content of the sheets D4-6 is based on the QR code d4 printed on the sheet D4. It is set in the QR code d4 that the storage destination is drive D, the file type is JPEG, the color mode is color and the image resolution is 600 dpi. As different image data are generated for each of the sheets D4-6, the file names thereof are different as well.

### A Second Embodiment

In the second embodiment, the image processing apparatus prints the QR code merely on the first page within the sheets to be subjected to printing processing.

In the second embodiment, the image processing apparatus 100 executes image forming processing and image reading processing.

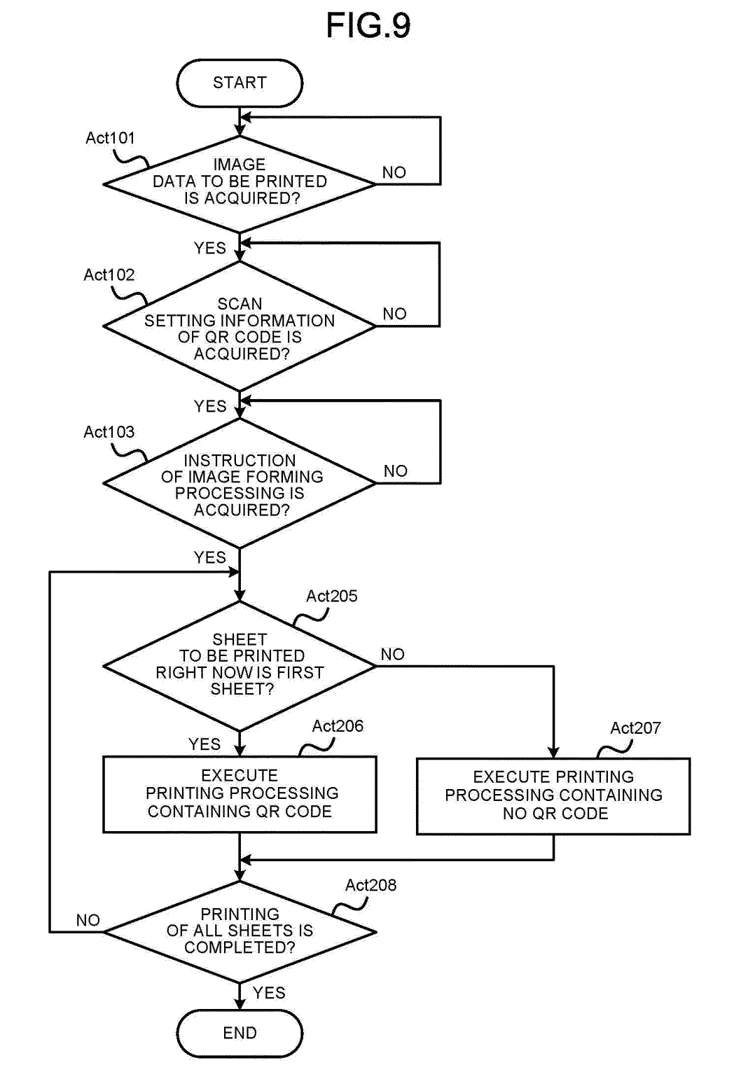

FIG. 9 is a flowchart illustrating printing processing carried out in the second embodiment.

The processing in ACT 101-ACT 103 is the same as that in ACT 101-ACT 103 in the first embodiment.

In ACT 205, if the sheet to be printed right now is the first sheet (YES in ACT 205), the flow proceeds to ACT 206. On the other hand, in ACT 205, if the sheet to be printed right now is not the first sheet (NO in ACT 205), the flow proceeds to ACT 207.

In ACT 206, the control section 800 controls the image forming section P to print the printing target image and the QR code on the sheet.

In ACT 207, the control section 800 controls the image forming section P to merely print the printing target image on the sheet. The QR code is not printed on the sheet in ACT 207.

In ACT 208, if the printing processing on all the sheets in the sheet group which are supposed to be printed is completed (YES in ACT 208), the printing processing is ended. On the other hand, in ACT 208, if the printing processing on all the sheets in the sheet group which are supposed to be printed is not completed (NO in ACT 208), the flow proceeds to ACT 205.

In addition, the image reading processing carried out in the present embodiment is the same as that in the first embodiment.

In each embodiment, the identifier for specifying the handling of the scanning data is not limited to the QR code. The identifier may be, for example, a barcode or a text, as long as the identifier contains the information about the handling of the scanning data.

In each embodiment, the storage destination of the image data generated through the scanning processing is not limited to the image processing apparatus. For example, the storage destination may also be the external machine which is connected with the image processing apparatus through a network.

The input screen for inputting the scan setting information is not limited to be displayed on the image processing apparatus. The input screen may be displayed on, for example, the external machine which is connected with the image processing apparatus through a network.

Further, the image processing apparatus may acquire either of the target data to be printed and the scan setting information indicated by the QR code first.

In each embodiment, though the image forming section is constructed integrally with the image reading section, the present invention is not limited to this. For example, the image forming section and the image reading section may be constructed separately. In this case, the image forming section and the image reading section are connected with each other through a network.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image processing apparatus comprising:
a memory that stores instructions; and
a processor, coupled to the memory, that facilitates execution of the instructions to perform operations, comprising:
acquiring image data;
acquiring identifier information indicating an identifier which is to be printed on a same sheet together with the image data and is used for specifying the handling of scanning data acquired when scanning the sheet printed with the identifier; and
forming an image indicating the identifier information on a sheet when forming an image based on the image data on the sheet.

2. The image processing apparatus according to claim 1, the operations further comprising
printing the identifier for each of a plurality of sheets based on the identifier information, in a case where the image is formed on the plurality of sheets.

3. The image processing apparatus according to claim 1, the operations further comprising
printing the identifier based on the identifier information only on the sheet on which the first page of image is printed, in a case where there is a plurality of pages of image data.

4. The image processing apparatus according to claim 1, wherein
the identifier information specifies, as the handling of the scanning data obtained when scanning the image containing the identifier, at least one of the storage destination of the scanning data and the file type when storing the scanning data.

5. An image processing system, comprising:
a processor; and
a memory that stores executable instructions that when executed by the processor perform operations, comprising:
acquiring an image data; acquiring identifier information indicating an identifier which is to be printed on a same sheet together with the image and is used for specifying the handling of scanning data acquired when scanning the sheet printed with the identifier; and forming an image indicating the identifier information on a sheet when forming an image based on the image data on the sheet; and
scanning an image formed on a sheet; acquiring the identifier information based on an image indicating the identifier contained in a scanned image obtained when the sheet is scanned on which the image and the image indicating the identifier are printed; and processing the scanned image of the image formed on the sheet together with the acquired identifier information according to the handling specified by the identifier information acquired by the identifier information reading section.

6. The image processing system according to claim 5, the operations further comprising
printing the identifier for each of the plurality of pages based on the identifier information, in a case where the image is formed on the plurality of sheets.

7. The image processing system according to claim 5, the operations further comprising
printing the identifier based on the identifier information only on the sheet on which the first page of image is printed, in a case where there is a plurality of pages of image data acquired by the target data acquisition section.

8. The image processing system according to claim 5, wherein
the identifier information specifies, as the handling of the scanning data obtained when scanning the image containing the identifier, at least one of the storage destination of the scanning data and the file type when storing the scanning data.
